(19) United States
(12) Patent Application Publication
(10) Pub. No.: US 2007/0237390 A1
(43) Pub. Date: Oct. 11, 2007

(54) USER INTERFACE TO IMAGE KEYING

(75) Inventors: Kevin Shaw, Hampshire (GB); Richard Shackleton, Hertfordshire (GB)

Correspondence Address: CONNOLLY BOVE LODGE & HUTZ LLP, 1875 EYE STREET, N.W., SUITE 1100, WASHINGTON, DC, 20036, US

(73) Assignee: DIGITAL VISION AB, Solna (SE)

(21) Appl. No.: 11/733,818

(22) Filed: Apr. 11, 2007

Related U.S. Application Data
(60) Provisional application No. 60/744,631, filed on Apr. 11, 2006.

(51) Int. Cl. G06K 9/00

(52) U.S. Cl. 382/162

(57) ABSTRACT

A system for processing the creation of an image matte, includes a set of multi-dimensional control functions, each having a single control unit for adjustment of more than one Keying parameter, thereby enabling a person to adjust more than one parameter when moving the single control unit.

### CROSS REFERENCE TO RELATED APPLICATIONS

This application is a Non-provisional Application claiming benefit under 35 USC §119 (e) to Provisional Application No. 60/744,631 filed on Apr. 11, 2006, the entire contents of which are incorporated herein by reference.

### BACKGROUND

The invention refers to the field of a control system for optimizing the creation of a monochrome image matte (also referred to as an alpha-channel) from a color image, with respect to a set of parameters such as hue, lightness and saturation (HLS) or red, green and blue (RGB) color qualifiers.

An algorithm used to obtain a monochrome image matte (also referred to as an alpha-channel or key) from a color image is commonly referred to as Keying. The resulting image matte has many uses including the isolation of image areas for color correction, visual effect application and foreground over background (also referred to as RGBA) image compositing. Variations on the algorithms are widely spread and are commonly used in software applications such as Adobe After Effects and Autodesk Combustion as well as professional color enhancement systems.

Keying employs the qualification of image regions based on color and intensity. Most commonly this is specified in the form of a combination of hue, lightness and saturation qualifiers or a combination of red, green and blue qualifiers. Each qualifier provides limits of color or intensity values, isolating pixels within the image region, pixels outside the image region or pixels falling within a bounding region where fall-off (or softness) between inside and outside can be included.

Typical Keying parameters involved are “Center”, “Width” and “Fall-off” each per Hue, Lightness and Saturation or Red, Green and Blue intensity and color qualifiers respectively.

A commonly used user interface approach to controlling the parameters is a graph representation manipulated through mouse and keyboard or pen and tablet. In the specialized field of color correction a physical control surface often provides individual control of each parameter through a rotary input dial (knob).

In seeking the optimal parameter settings for a required image region it is often the case that many parameter adjustments are required and this is a complex and time consuming task.

### BRIEF SUMMARY

In one embodiment, a system for processing a creation of an image matte includes a set of multi-dimensional control functions, each comprising a single control unit for adjustment of more than one Keying parameter, thereby enabling a person to adjust more than one parameter when moving said single control unit.

### BRIEF DESCRIPTION OF THE DRAWINGS

FIG. 1 provides a two-dimensional joy-stick and one dimensional slider control graphical user interface.

FIG. 2 provides another possible implementation using a trackball and rotational ring.

FIG. 3 provides a configuration of a complete set of three multi-dimensional control functions.

FIG. 4 provides another example to incrementally cover the image region required.

### DETAILED DESCRIPTION

The objective of the invention is a system for processing a creation of an image matte, comprising a set of multi-dimensional control functions, each comprising a single control unit for adjustment of more than one Keying parameter, thereby enabling a person to adjust more than one parameter when moving said single control unit. The system of the invention allows faster set-up of the processing of the creation of an image matte.

An embodiment of the system comprises a set of three multi-dimensional control functions, each comprising a single control unit for adjustment of more than one Keying parameter, thereby enabling a person to adjust more than one parameter from a single control unit, without interruption.

The three control functions represent three inputs to the keyers of a color space, like Hue, Lightness and Saturation or Red, Green and Blue.

The possibility to adjust more than one parameter by one control unit makes the setup faster, simplifies the operation of adjusting colors and intensity to produce an image matte and also gives advantages for making creative enhancements of an image through image matte creation.

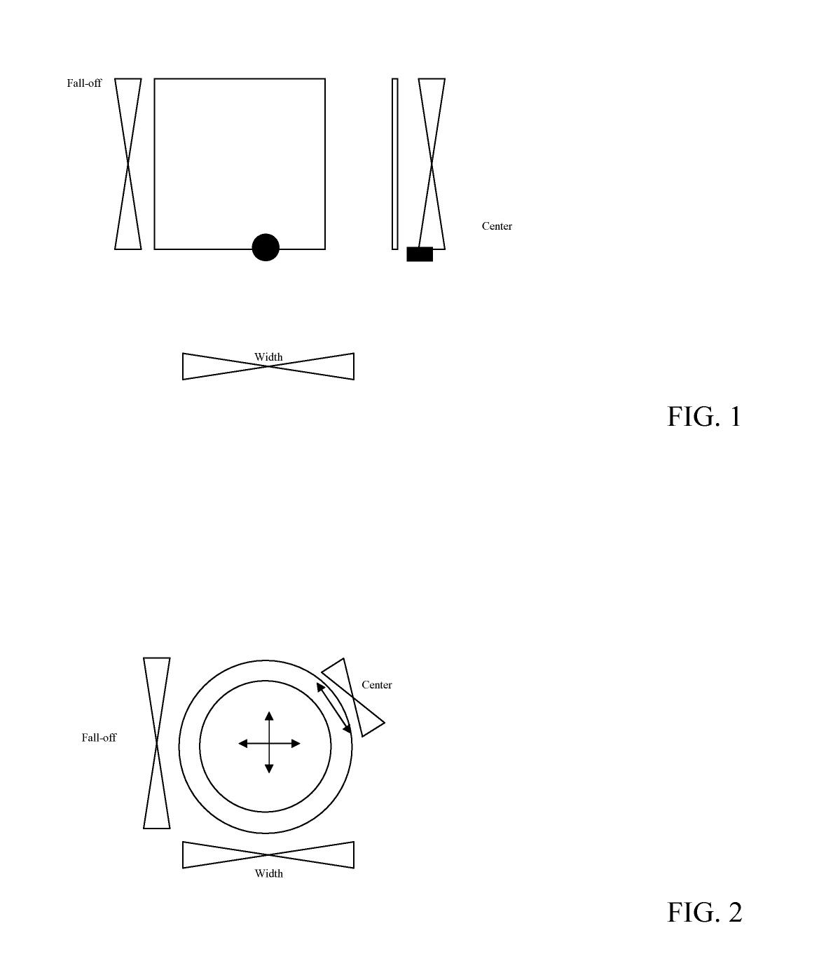

An example of this type of control function combination is to introduce a two-dimensional joy-stick and one dimensional slider control (or functionality-wise similar) graphical (or functionality-wise similar) user interface similar to outlined in the attached FIG. 1.

Another possible implementation is using a trackball and rotational ring as illustrated in FIG. 2.

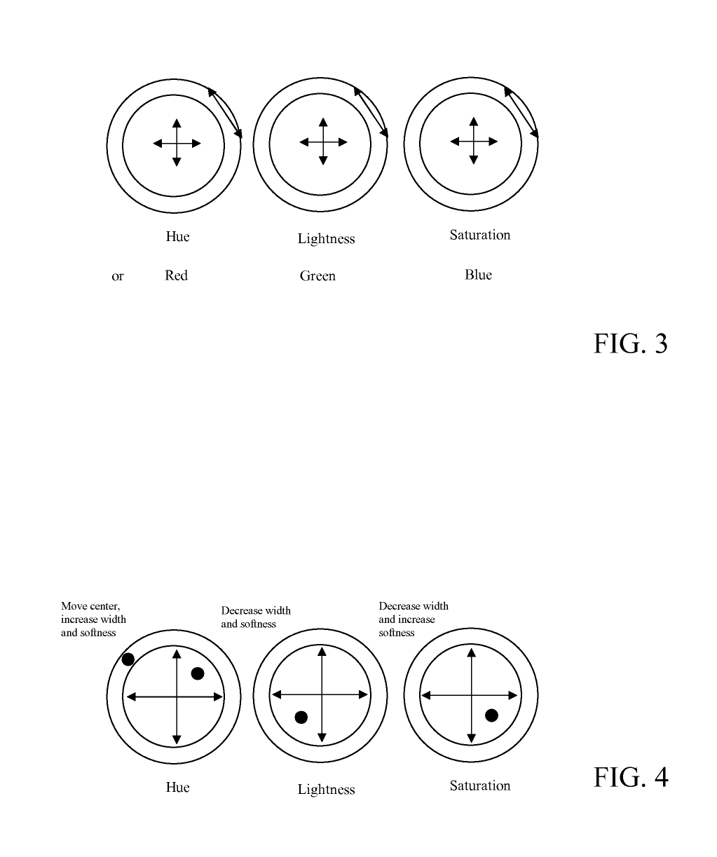

The complete set of three multi-dimensional control functions would be presented in a configuration similar to FIG. 3.

A typical example for specifying an image matte may be to select a hue center, increase the width and softness of the hue region, and increase the width and softness of the lightness and saturation regions.

Another example may be to decrease the width and softness of the hue, lightness and saturation regions and then selecting a center for hue, saturation and lightness before increasing width and softness to incrementally cover the image region required, as illustrated in FIG. 4.

The above equally holds for the Keying parameters Red, Green and Blue.

The feature provides an enhanced user interface that allows faster and more accurate creation of image mattes through multiple parameter control. The combination of trackballs in the physical implementation suits simultaneous two-handed use allowing the control of up to 6 parameters simultaneously.

What is claimed as new and desired to be protected by Letters Patent of the U.S. is:

1. A system for processing a creation of an image matte, comprising a set of multi-dimensional control functions, each comprising a single control unit for adjustment of more than one Keying parameter, thereby enabling a person to adjust more than one parameter when moving said single control unit.

2. A system in accordance with claim 1, comprising at a set of three multi-dimensional control functions.

3. A system in accordance with claim 2, comprising that each of the three multi-dimensional control functions represent a different parameter of a color space.

4. A system in accordance with claim 3, comprising a set of control units comprising at least one trackball and rotational ring multiple parameter control unit.

5. A system in accordance with claim 4, comprising a set of three trackball and rotational ring multiple parameter control units.

6. A system in accordance with claim 3, comprising a set of control units comprising at least one two-dimensional joy-stick.
